(19) United States
(12) Patent Application Publication
(10) Pub. No.: US 2014/0169759 A1
(43) Pub. Date: Jun. 19, 2014

(54) Systems And Methods For Merging Media Content

(71) Applicant: Craig Michael Schmieder, Dallas, TX (US)

(72) Inventor: Craig Michael Schmieder, Dallas, TX (US)

(21) Appl. No.: 14/079,961

(22) Filed: Nov. 14, 2013

Related U.S. Application Data
(60) Provisional application No. 61/738,972, filed on Dec. 18, 2012.
(60) Provisional application No. 61/773,676, filed on Mar. 6, 2013.

(51) Int. Cl. H04N 9/87; G06F 17/30

(52) U.S. Cl. CPC H04N 9/8715; G06F 17/3082
USPC 386/241

(57) ABSTRACT

A computer implemented method for storing and delivering to a consumer a first commentary and a second commentary comprises the steps of storing in a first commentary record of a commentary database the first commentary and a first set of time indexing data, and storing in a second commentary record of the commentary database the second commentary and a second set of time indexing data. A content delivery device is used to playback the media content for the consumer. The playback of the media content is paused after the playback of the first scene, and the first commentary is played for the consumer on the content delivery device. The second commentary is next played on the content delivery device after the playback of the first commentary has ended. Playback of the media content is resumed on the content delivery device upon conclusion of the second commentary.

### CROSS-REFERENCE TO RELATED APPLICATIONS

This application claims priority to U.S. Provisional Patent Application No. 61/773,676 filed Jun. 13, 2013, and to U.S. Provisional Patent Application No. 61/738,972 filed Dec. 18, 2012. The disclosure of each is incorporated herein by reference in its entirety.

### FIELD OF THE INVENTION

The invention relates generally to the field of creating and merging data. More specifically, the invention relates to the field of creating data and synchronizing this data with pre-existing media content.

### SUMMARY

Systems and methods for obtaining commentaries associated with media content(s) from contributors, storing said commentaries, and delivering these commentaries in sync with the media content(s) to consumers are disclosed herein. According to one embodiment, a system for: (a) storing a first commentary associated with a first media content and a second commentary associated with a second media content; and (b) delivering the first commentary and the second commentary to a consumer in sync with the first media content and the second media content, respectively, comprises a content playback device configured for the playback of the first media content and the second media content. The content playback device has a first processor in data communication with a first non-transitory computer memory, a first input device, a first output device, and a first networking device. The system further includes a content acquisition device configured for the recording of the first and the second commentaries provided by a contributor. The content acquisition device has a second processor in data communication with a second non-transitory computer memory, a second input device, a second output device, a second networking device, and a microphone. A databank is accessible over a network and includes at least a commentary database and a contributor database. The first commentary is housed in the commentary database in a first commentary record and the second commentary is housed in the commentary database in a second commentary record. The first commentary record further comprises a first set of time indexing data and the second commentary record further comprises a second set of time indexing data for allowing synchronization of the first commentary and the second commentary with the first media content and the second media content, respectively. The contributor database houses an attribute of the contributor. Each of the first commentary and the second commentary are delivered to a consumer in sync with the first media content and the second media content, respectively.

A computer implemented method for storing and delivering to a consumer a first commentary provided by a first contributor and a second commentary provided by a second contributor is disclosed according to another embodiment. Each of the first and the second commentaries are associated with a first scene of a media content. The method comprises the steps of storing in a first commentary record of a commentary database the first commentary and a first set of time indexing data, and storing in a second commentary record of the commentary database the second commentary and a second set of time indexing data. A content delivery device having at least a processor, a non-transitory memory, an input device, an output device, and a networking device is used to playback the media content for the consumer. The playback of the media content is caused to be paused after the playback of the first scene, and the first commentary is then played for the consumer on the content delivery device. The second commentary is next played on the content delivery device after the playback of the first commentary has ended. Playback of the media content is resumed on the content delivery device upon conclusion of the second commentary.

A computer implemented method for storing and delivering to a consumer a first commentary provided by a first contributor and a second commentary provided by a second contributor is disclosed according to yet another embodiment. The first commentary is associated with a first scene of a media content and the second commentary is associated with a second scene of the media content. The method comprises the step of storing in a first commentary record of a commentary database the first commentary and a first set of time indexing data. The method further comprises the step of storing in a second commentary record of the commentary database the second commentary and a second set of time indexing data. A content delivery device having at least a processor, a non-transitory memory, an input device, an output device, and a networking device is used to playback the media content for the consumer. The playback of the media content is caused to be paused after the playback of the first scene, and the first commentary is played for the consumer on the content delivery device while the playback of the media content is paused. The playback of the media content is resumed when the first commentary concludes. The playback of the media content is caused to be paused again after the playback of the second scene, and the second commentary is played for the consumer on the content delivery device while the playback of the media content is paused. The playback of the media content is resumed on the content delivery device once the second commentary concludes.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 shows a schematic illustrating electronic communication between various components of a media viewing device;

FIG. 2 shows the media viewing device being used for the viewing of a movie;

FIG. 3 shows a schematic illustrating electronic communication between various components of a content acquisition device;

FIG. 4 shows a flowchart illustrating a method to record a commentary, according to an embodiment;

FIG. 5 shows identifying characteristics of a media content being entered into a database via the media viewing device;

FIG. 6 shows identifying attributes of the commentary being entered into a database via the media viewing device;

FIG. 7 shows the contents of a commentary record in a commentary database;

FIG. 8 shows part of the constituent databases that comprise a databank;

FIG. 9 shows the contents of a contributor record in a contributor database;

FIG. 10 shows an application programming interface of a social media database sending updates to social media platforms;

FIGS. 11 through 13 show exemplary contents of the databank of FIG. 8;

FIG. 14 shows a schematic illustrating electronic communication between various components of a content delivery device;

FIG. 15 shows a flowchart illustrating a method to consume a commentary, according to an embodiment;

FIG. 16 shows a home screen of a media player interface;

FIGS. 17 and 18 show exemplary results of search queries with filters;

FIG. 19 shows a contributor being rated according to a contributor ratings criteria;

FIG. 20 shows exemplary contents of a ratings database;

FIG. 21 shows the home screen of FIG. 16 after the updating of contributor and commentary ratings; and

FIG. 22 shows a flowchart illustrating a method for utilizing a multiple comment notification mode, according to an embodiment.

### DETAILED DESCRIPTION

Embodiments of the present invention provide systems and methods for creating audio and other data and synchronizing this data with pre-existing media content. Creators and distributors of media content (e.g., movies, songs, television shows, news casts, et cetera) are routinely looking for ways to increase the revenues generated by their media content. Consider, for example, the life cycle of a motion picture, which typically grosses the highest revenues when it is first played in theatres. The motion picture may then be released on digital versatile discs (or “digital video discs” i.e., “DVDs”) and/or streamed by media content outlets (e.g., Netflix®, Hulu®, Hulu Plus, Amazon®, Youtube®, Direct TV®, Vudu, et cetera) and gross additional (though typically smaller) revenues. The motion picture may subsequently be re-released on blue-ray discs or DVDs (e.g., with commentary from actor(s), director(s), producer(s) and/or other content such as deleted scenes) so that it could generate even greater revenues.

Similarly, a song may first be introduced by a musical band in concerts, and then be released on other media (e.g., compact discs, radio, iTunes®, et cetera) so that it can generate additional revenues. The song may then be re-released (e.g., with the vocals removed for allowing the song to be played on karaoke devices) so that the revenues generated by the song are further enhanced.

While motion picture DVDs having commentary (from an actor, for example) and karaoke songs are interactive to some extent, they do not harness fully the benefits afforded by interactive entertainment. For example, a motion picture DVD may include commentary from only a select group of individuals, and may not incorporate various comments that a multitude of other media consumers (e.g., avid movie goers, history buffs, professional or amateur critics, comedians, regular individuals, et cetera) may have about the motion picture. Similarly, karaoke songs may generally only be performed and enjoyed by a select group of individuals (e.g., those present at a karaoke bar), and karaoke song performances may not be disseminated as widely as the original songs themselves. The present invention addresses these and related concerns, and in broad terms, discloses systems and methods for: (1) making existing media content fully interactive by allowing users to provide commentaries (in the form of interpretive or explanatory remarks, mimicry, parodies, criticism, voice overs, trivia, et cetera) on existing media content; (2) compiling and organizing the users' commentaries for consumption by the general public; and (3) providing a mechanism to rate the numerous commentators and commentaries based on various criteria so as to enable viewers to choose the one or more commentators and commentaries according to their personal tastes and preferences.

### Content Acquisition

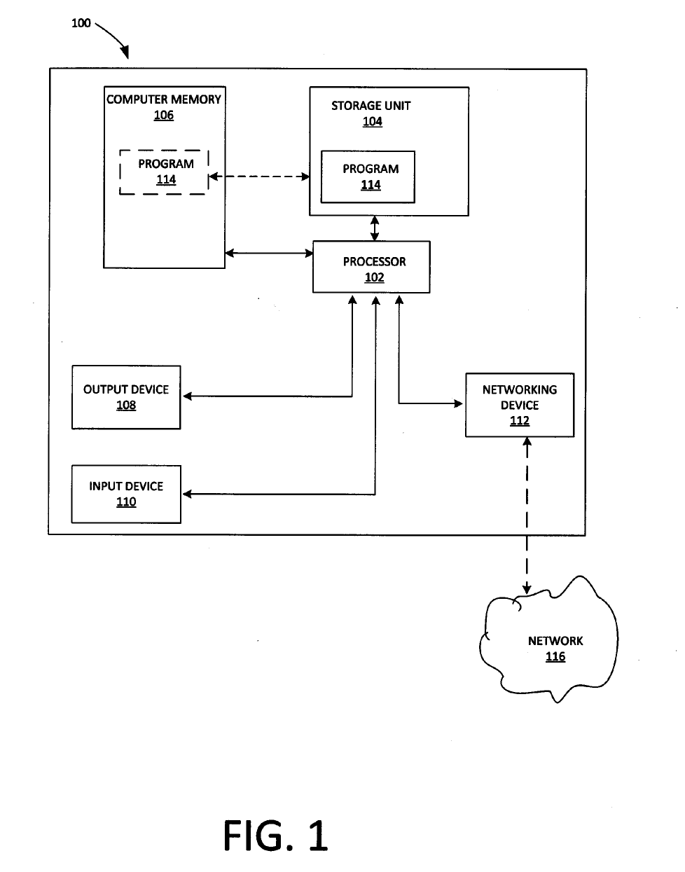

Attention is directed now to FIG. 1, which shows a media viewing device (or content playback device) 100. The media viewing device 100 may be any smart device, for example, a desktop computer, a laptop computer, a tablet, a smart phone, a smart television (incorporating, for instance, Apple TV or Roku), a blue-ray disc player, et cetera. The media viewing device 100 may have a processor (or controller) 102, which may be in data communication with a storage unit 104, a computer memory 106, an output device 108, an input device 110, and a networking device 112.

The storage unit 104 may be, for example, a disk drive that stores programs and data, and the storage unit 104 is illustratively shown storing a program 114 embodying the steps and methods set forth below. It should be understood that the program 114 could be broken into subprograms and stored in storage units of separate devices and that data could be transferred between those storage units using methods known in the art. A dashed outline within the computer memory 106 represents the software program 114 loaded into the computer memory 106 and a dashed line between the storage unit 104 and the computer memory 106 illustrates the transfer of the program 114 between the storage unit 104 and the computer memory 106.

The output device 108 may be a display screen (e.g., a CRT, LCD, Plasma, et cetera) and/or speakers, or any other appropriate visual or audio output device whether now known or later invented. The input device 110 may comprise keys, switches, knobs, infrared or other sensors, a remote controller, a microphone, a stylus pen, a touch screen, a DVD or VHS input slot, et cetera. The networking device 112 may be any networking device that allows the media viewing device 100 to connect to network 116, such as a switch, a router, a modem, a networking card, et cetera. The network 116 may be a local area network, a private network, the World Wide Web, or any other suitable network 116.

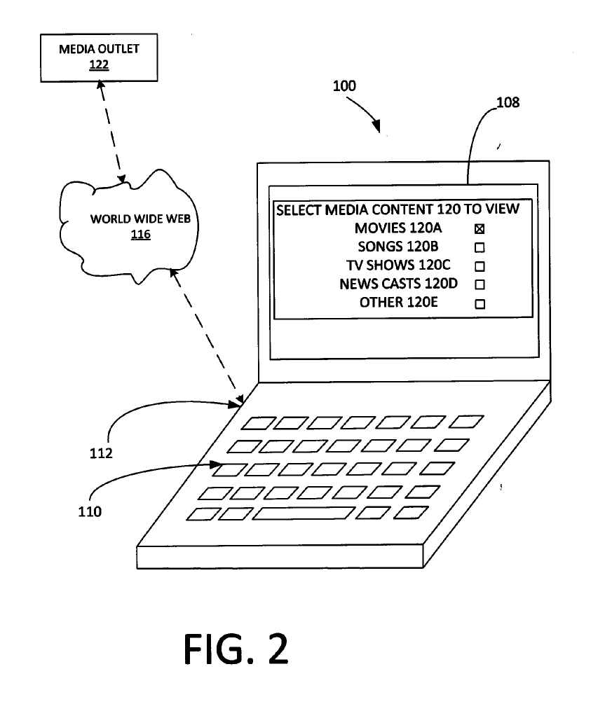

A user (or contributor) 118 may use the media viewing device 100 to access and enjoy different types of media content 120, which may include, for example, movies 120A, music videos 120B, television shows 120C, news casts 120D, or other media content 120E. For example, as shown in FIG. 2, the user 118 may use the media viewing device 100 (a laptop computer in this example) to stream a movie 120A via a media outlet 122 (such as Netflix®, Hulu, Hulu Plus, Direct TV, Vudu, Amazon, or another static or dynamic media content repository, et cetera). Alternatively, the user 118 may use the media viewing device 100 to view a music video 120B on a DVD, for example.

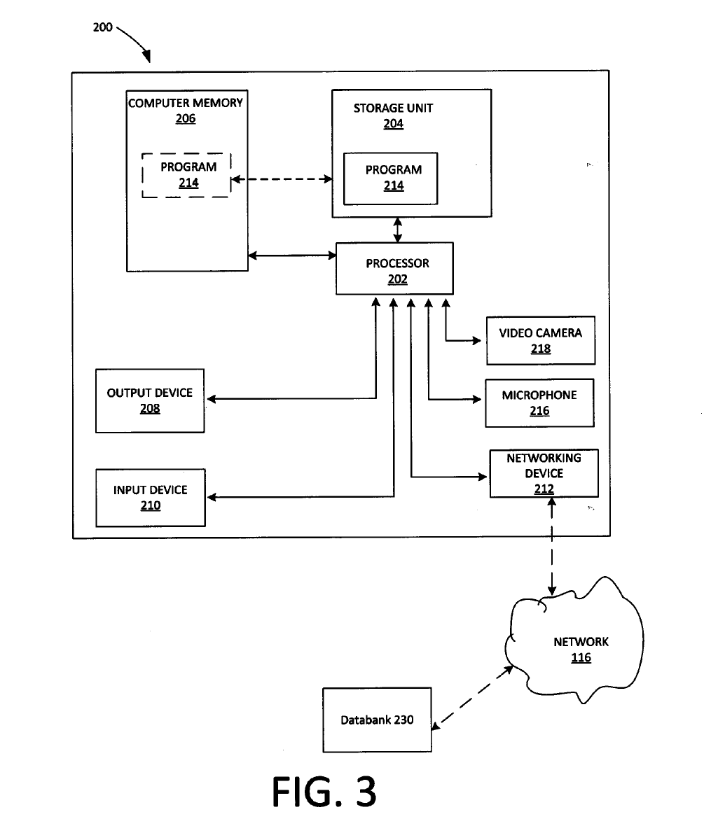

FIG. 3 shows a content acquisition device 200, which may also be one or more of a plurality of smart devices. Much like the media viewing device 100, the content acquisition device 200 may comprise a processor 202 in data communication with a storage unit 204, a computer memory 206, an output device 208, an input device 210, and a networking device 212. The storage unit 204 may be, for example, a disk drive that stores programs and data, and the storage unit 204 is illustratively shown storing a program 214 embodying the steps and methods set forth below. It should be understood that the program 214 could be broken into subprograms and stored in storage units of separate devices (e.g., as program 114 in storage unit 104 of the media viewing device 100) and that data could be transferred between those storage units using methods known in the art. A dashed outline within the computer memory 206 represents the software program 214 loaded into the computer memory 206 and a dashed line between the storage unit 204 and the computer memory 206 illustrates the transfer of the program 214 between the storage unit 204 and the computer memory 206.

Akin to the output device 108 of the content playback device 100, the output device 208 of the content acquisition device 200 may be a display screen and/or speakers, or any other appropriate visual or audio output device whether now known or later invented. The input device 210 may comprise keys, switches, knobs, infrared or other sensors, a remote controller, a stylus pen, a touch screen, a DVD input, et cetera. The networking device 212 may be any networking device that allows the content acquisition device 200 to connect to the world wide web 116, such as a switch, a router, a modem, a networking card, et cetera.

One of the main differences between the content playback device 100 and the content acquisition device 200 may be that the content acquisition device 200 may further include a microphone 216 in data communication with the processor 202. In some embodiments, a camera 218 (e.g., a web or other video camera, a still camera, et cetera) may also be integrally or separately provided with the content acquisition device 200. Of course, while not required, the content playback device 100 may also include a camera and/or a microphone, particularly in embodiments where the content playback device 100 and the content acquisition device 200 are the same device, as discussed in more detail below.

People of skill in the art will appreciate that every media content 120 may have one or more identifying characteristics 130 (e.g., a cast 132, a language 134, a duration 136, a director(s) 138, a writer(s) 140, a genre 142, a release date 144, et cetera). Further, a commentary 150 provided by the user 118 about the media content 120 may similarly have one or more identifying attributes 152 (e.g., the commentary 150 may be a mimicry 154, a parody 156, a criticism 158, a voice over 160, trivia 162, or other commentary 163, and may have a language 164, a duration 166, a recording date 168, et cetera).

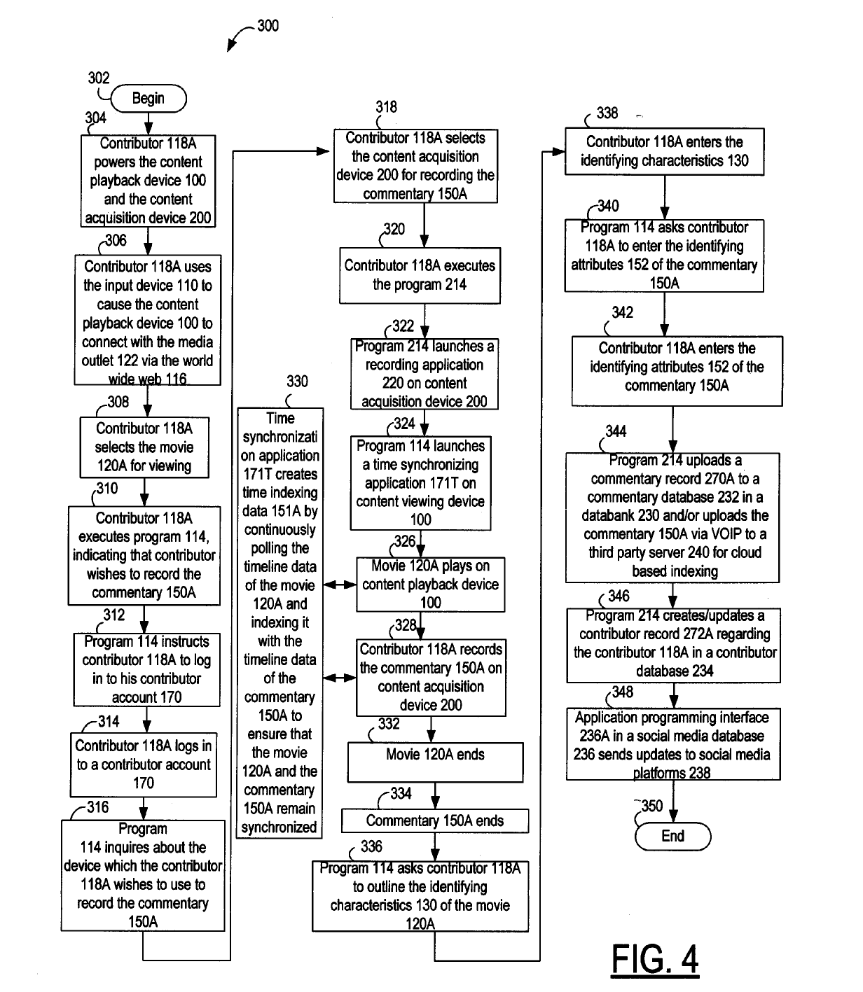

For the purposes of illustration, assume now that a user (or contributor) 118A named Jon Jones utilizing the content playback device 100 to view media content 120 (e.g., a movie 120A such as the Godfather, Caddyshack, Ocean's 11, Shrek, et cetera) wishes to provide a commentary 150A about the media content 120 on the content acquisition device 200. Attention is directed now to FIG. 4, which illustrates a method 300 for allowing the contributor 118A to record the commentary 150A.

The method 300 may begin at step 302, and at step 304, the contributor 118A may power the content playback device 100 and the content acquisition device 200. People of skill in the art will appreciate from the disclosure herein that the content acquisition device 200 may also be powered at a subsequent step, and that the powering of the devices 100, 200 may not be required to effectuate the method 300 where the devices 100, 200 are already powered up at step 302. Once the devices 100, 200 are powered, at step 306, the contributor 118A may use the input device 110 and the networking device 112 of the content playback device 100 to connect with the media outlet 122 via the world wide web 116. At step 308, the contributor 118A may select the movie 120A for viewing (from, for example, a listing of media content 120 made available by the media outlet 122). Alternatively, the contributor 118A may have selected a song 120B, a television show 120C, a news cast 120D or other media content 120E for viewing on the content playback device 100.

At step 310, the contributor 118A may execute the program 114 to indicate that the contributor 118A wishes to record the commentary 150A. At step 312, the program 114 may instruct the contributor 118A (e.g., via the processor 102 and the output device 108) to log into a contributor account 170 to record the commentary 150A, and the contributor 118A may do so at step 314 (using, for example, the input device 110). The account 170 may be specific to the contributor 118A and be password protected and/or encrypted. In some embodiments, the account 170 may be tied to (and have the same log-in information as) an e-mail account of the contributor 118A and/or an account of the contributor 118A on a social media platform 238 (e.g., Facebook®, Myspace®, Twitter®, LinkedIn°, et cetera), as discussed in more detail below.

Once the contributor 118A logs into the account 170, at step 316, the program 114 may inquire about the device which the contributor 118A wishes to use to record the commentary 150A. For example, the program 114 may cause the output device 108 to display a list of all the devices on which all or part of the program 114 (and/or the program 214) is stored and instruct the contributor 118A to select one of these devices to record the commentary 150A. Alternatively, or in addition, the program 114 may allow the contributor 118A to manually enter (using, for example, the input device 110) the device on which the commentary 150A is to be recorded. At step 318, the contributor 118A may select the content acquisition device 200 for recording the commentary 150A. Alternatively, as discussed further below, the contributor 118A may have chosen at step 318 to view the movie 120A and record the commentary 150A on the same device (e.g., the content playback device 100).

At step 320, after indicating that the contributor 118A wishes to record the commentary 150A on the content acquisition device 200, the contributor 118A may execute the program 214 on the content acquisition device 200. In some embodiments, the program 214 may be executed automatically on the device chosen by the contributor 118A to record the commentary 150A. Further, as outlined above, the program 214 and the program 114 may in some embodiments be the same program (i.e., the functionality of the program 214 may be encompassed by the program 114).

At step 322, the program 214 may cause a recording application 220 to be launched on the content acquisition device 200. The recording application 220 may be configured to allow the contributor 118A to use the microphone 216 and/or the video camera 218 of the content acquisition device 200 to record the commentary 150A. At step 324, the program 114 may launch a time synchronizing application 171T on the content playback device 100.

The movie 120A may begin to play on the content playback device 100 at step 326. As the contributor 118A views the movie on the content playback device 100, the contributor 118A may at step 328 use the microphone 216 (and/or the video camera 218) of the content acquisition device 200 to simultaneously record the commentary 150A. For example, the contributor 118A may view a scene of the movie 120A and record a parody 156 of the scene in the commentary 150A. Or, for example, as the contributor 118A views a scene of the movie 120A, the contributor may record trivia 162 (e.g., background facts, information regarding the set, the actors, the storyline, et cetera) in the commentary 150A.

As discussed in more detail herein, a user (or consumer) 418A may subsequently be allowed to view the movie 120A and listen to (or watch) the commentary 150A recorded by the contributor 118A in conjunction therewith. However, in the absence of a time synchronizing mechanism, the commentary 150A may appear out of sync with the movie 120A to the consumer 418A. For instance, as people of skill in the art will appreciate, a particular scene may commence five minutes after the movie 120A is launched for viewing using one media outlet 122 (e.g., Netflix), and commence six minutes after the movie 120A is launched for viewing using a different media outlet 122 (e.g., Hulu), because of, for example, disparate buffering/streaming speeds of the different media outlets 122, differing length of previews, advertisements, starting credits, et cetera. Thus, a commentary 150A recorded with the movie 120A viewed using one media outlet 122 (e.g., Netflix) may similarly appear to be out of sync with the same movie 120A when that movie 120A is viewed using another media outlet 122 (e.g., Hulu). To address this problem, the time synchronizing application 171T may, at step 330, continuously (e.g., every microsecond, every millisecond, every second, every minute, et cetera) poll (over the web or local network 116) the timeline data of the movie 120A playing on the content playback device 100 and index it with the timeline data of the commentary 150A to ensure that the commentary 150A and the movie 120A remain synchronized. This polling, indexing and synchronization of the movie 120A and the commentary 150A at step 330 may initiate at the commencement of the movie 120A (and/or the commencement of the commentary 150A) and continue until the movie 120A ends (i.e., the step 330 may be continually performed for the duration of the steps 326, 328). As discussed below, time indexing data 151A which includes information about the indexed timelines of the movie 120A and the commentary 151A may be saved in a database.

The contributor 118A may continue to view the movie 120A on the content playback device 100 and simultaneously record the commentary 150A on the content acquisition device 200. The movie 120A may eventually end at step 332, and the contributor 118A may conclude the commentary 150A at step 334.

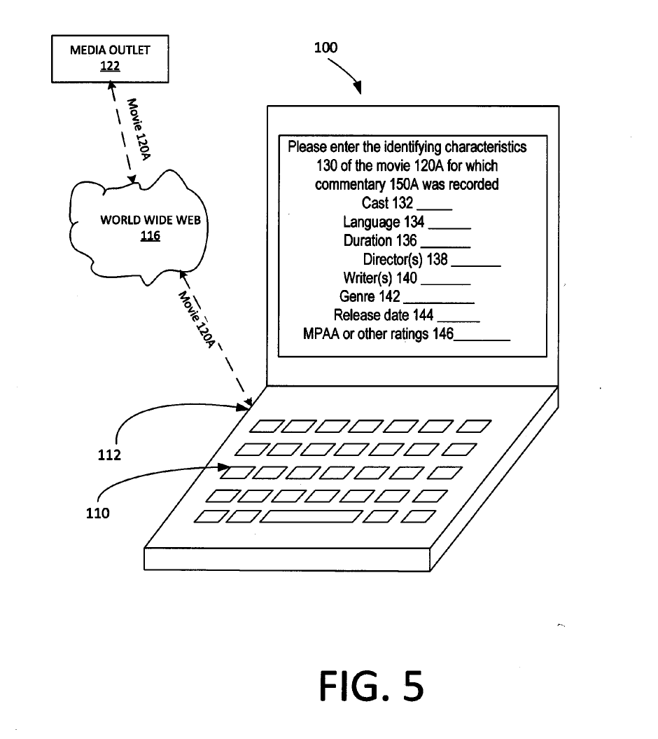

At step 336, the program 114 may instruct (e.g., via the processor 102 and the output device 108) the contributor 118A to outline the identifying characteristics 130 of the movie 120A. For example, as shown in FIG. 5, the program 114 may ask the contributor to enter the cast 132, language 134, duration 136, director(s) 138, writer(s) 140, genre 142, release date 144, et cetera, of the movie 120A, and the contributor 118A may enter the same at step 338 using the input device 110 of the content playback device 100.

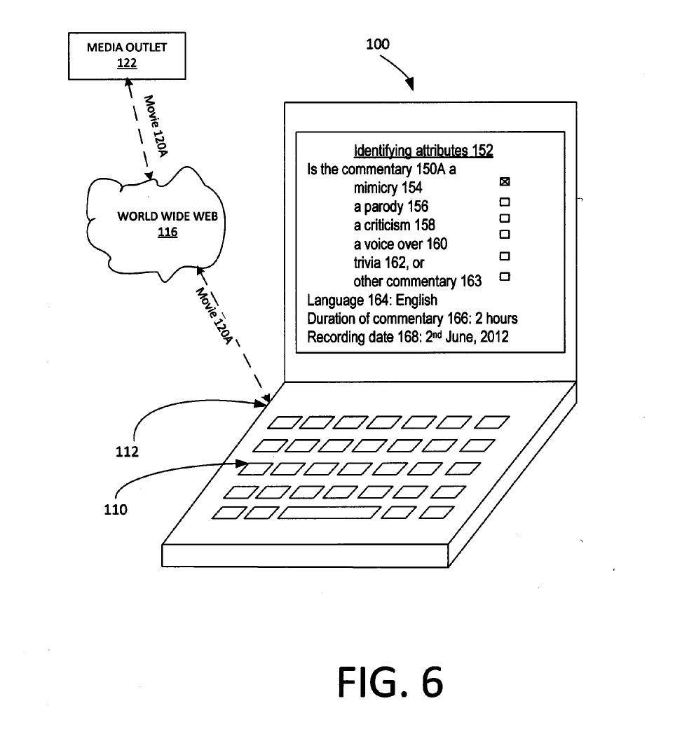

At step 340, the program 114 may ask the contributor 118A to enter the identifying attributes 152 of the commentary 150A. For example, as shown in FIG. 6, the program 114 may instruct the contributor 118A to identify whether the commentary 150A he recorded is a mimicry 154, a parody 156, a criticism 158, a voice over 160, trivia 162, or other commentary 163, et cetera. The program 114 may further instruct the contributor 118A to enter the language 164 of the commentary 150 along with its duration 166 and recording date 168. The contributor 118A may enter the identifying attributes 152 of the commentary 150A at step 342. In some embodiments, the language 164, the duration 166 and/or the recording date 168 of the commentary 150A may be automatically determined and saved by the program 114. People of skill in the art will appreciate the steps 336-342 of the method 300 are optional and may be omitted in some embodiments. People of skill in the art will further appreciate that while the disclosure herein outlines that the identifying characteristics 130 and the identifying attributes 152 are entered by the contributor 118A using the content playback device 100, that the identifying characteristics and attributes 130, 152, may similarly be entered by the contributor 118A using the content acquisition device 200 at the instruction of the program 214.

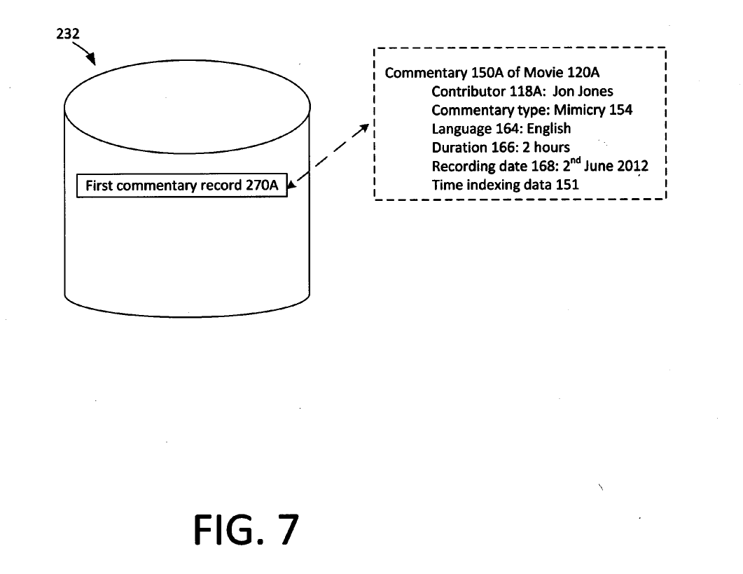

Assume for the purposes of this example that the contributor 118A enters (via the input device 110 or the input device 210) that the commentary 150A is a mimicry 154 in the English language (see FIG. 6). Assume further that the program 214 determines that the duration of the commentary 150A is two hours, and that its recording date is 2 Jun. 2012. At step 344, this information, along with the commentary 150A and the time indexing data 151A, may be uploaded via the world wide web 116 to a commentary database 232 and saved therein as a first commentary record 270A. More specifically, as shown in FIG. 7, the first commentary record 270A saved in the commentary database 232 may include the commentary 150A of the movie 120A as recorded by the contributor 118A, along with the name of the contributor 118A (i.e., Jon Jones), the commentary type (i.e., mimicry 154), the commentary language 164 (i.e., English), the commentary duration 166 (i.e., two hours), the commentary recording date 168 (i.e., 2 Jun. 2012), and the time indexing data 151A.

In some embodiments, the commentary 150A may be continuously uploaded to the commentary database 232 in fragments (e.g., portions of the commentary 150A may be continuously time indexed, parsed, and saved to the commentary database 232 as they are provided by the contributor 118A). In some embodiments, alternatively or in addition to being uploaded to the commentary database 232, the commentary 150A may also be uploaded to a third party server 240 via voice over Internet Protocol (VOIP) for cloud based encoding, indexing and subsequent retrieval. Further, in some embodiments, the identifying characteristics 130 of the movie 120A for which the commentary 150A is recorded may also be saved in the commentary database 232.

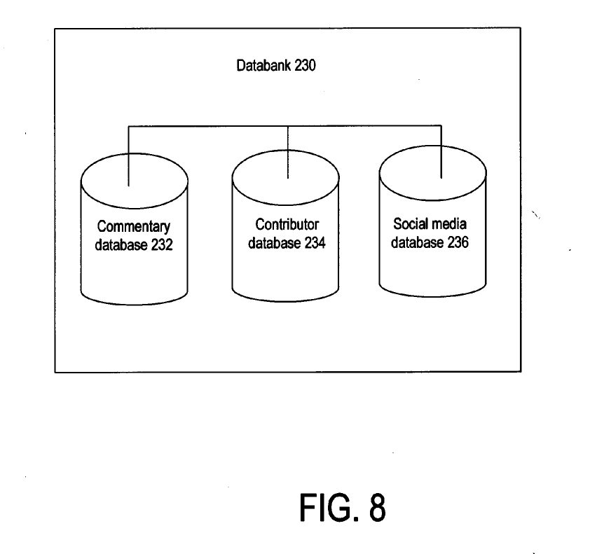

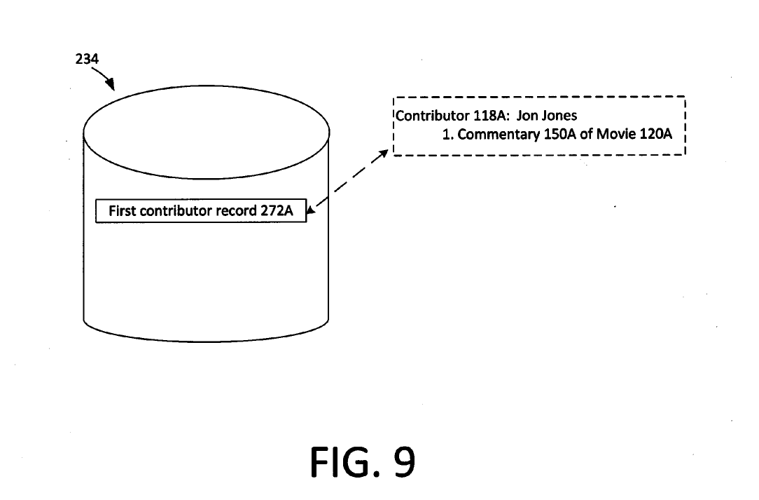

As shown in FIG. 8, the commentary database 232 may be part of a larger databank 230, which may also include a contributor database 234 and a social media database 236. Each of the commentary database 232, the contributor database 234, and the social media database 236 may be in data communication with each other. At step 346, the program 214 may update (or create) a first contributor record (or “profile”) 272A in the contributor database 234, which, as shown in FIG. 9, may include information about the contributor 118A. Specifically, the first contributor record 272A may comprise the name of the contributor 118A (i.e., Jon Jones) along with a listing of his commentaries.

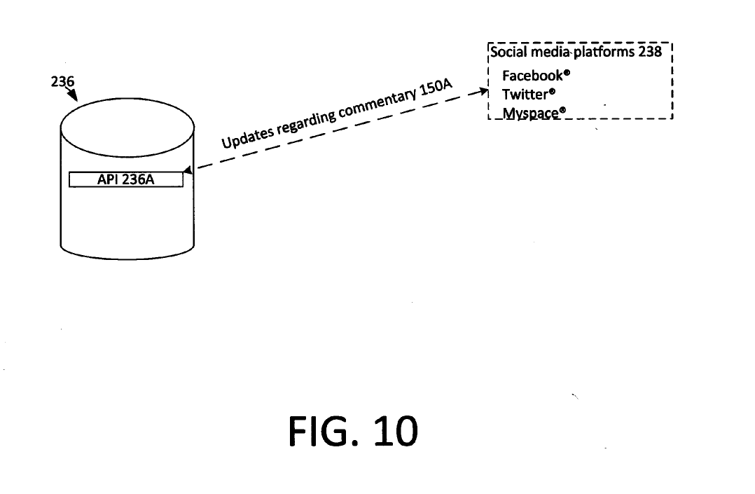

The social media database 236 may include an application programming interface 236A, which may be configured to interact with social media platforms 238 (e.g., Facebook®, Twitter®, Myspace®, LinkedIn®, et cetera) and send updates to these social media platforms 238 regarding the commentary 150A. For example, once the commentary 150A is uploaded to the commentary database 232, the application programming interface 236A of the social media database 236 may update the profile of the contributor of Facebook® and Myspace® at step 348 to indicate that the commentary 150A about the movie 120A has been uploaded by the contributor 118A (see FIG. 10). Alternatively, or in addition, the application program interface 236A may at step 348 send a “tweet” on Twitter® apprising the public that the commentary 150A has been uploaded by the contributor 118A. New social media platforms 238 may also of course be incorporated and updated in the same manner. The method 300 may end at step 350.

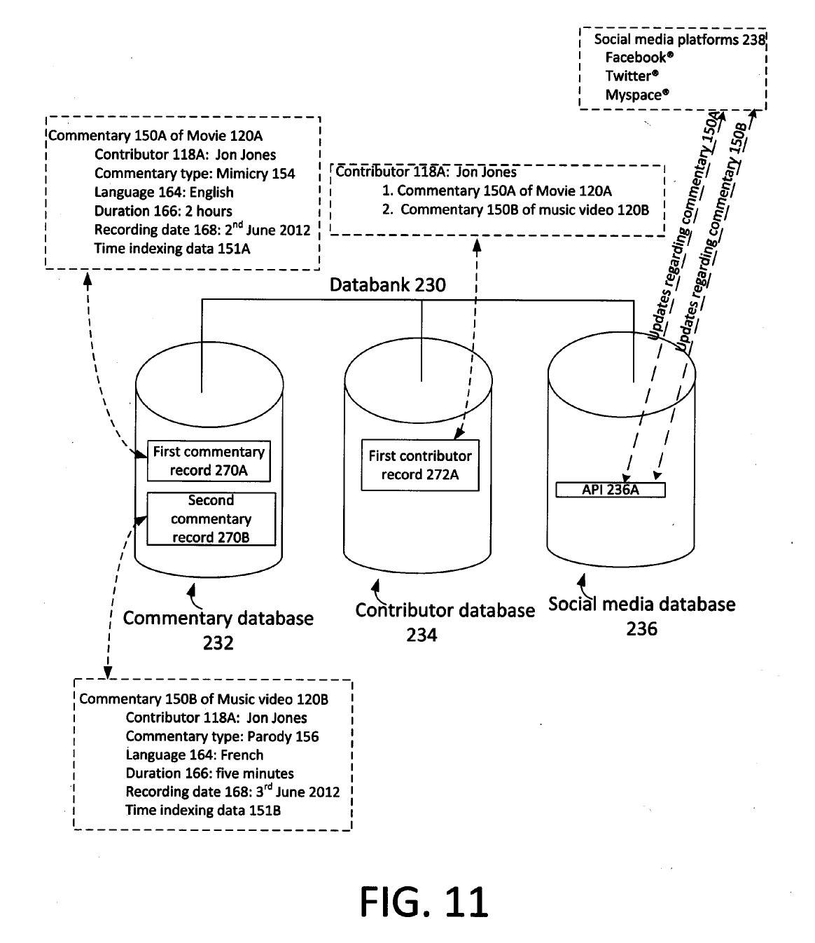

Assume now that the contributor 118A views a different media content 120 (e.g., a music video 120B) and creates a commentary 150B about the music video 120B using the method 300 (as outlined above). Assume also that the commentary 150B is a parody 156, has a duration 166 of five minutes, is recorded on 3 Jun. 2012, is in the French language, and has time indexing data 151B. As shown in FIG. 11, the commentary 150B and these identifying attributes 152 of the commentary 150B may be saved in the commentary database 232 in a second commentary record 270B. Further, as the commentary 150B is uploaded, the first contributor record 272 in the contributor database 234 may also be updated to indicate that the contributor 118A (i.e., Jon Jones) has created the commentary 150B of the music video 120B in addition to the commentary 150A of the movie 120A. The application programming interface 236A of the social media database 236 may further send updates to the social media platforms 238 regarding the commentary 150B, as discussed above with respect to the commentary 150A.

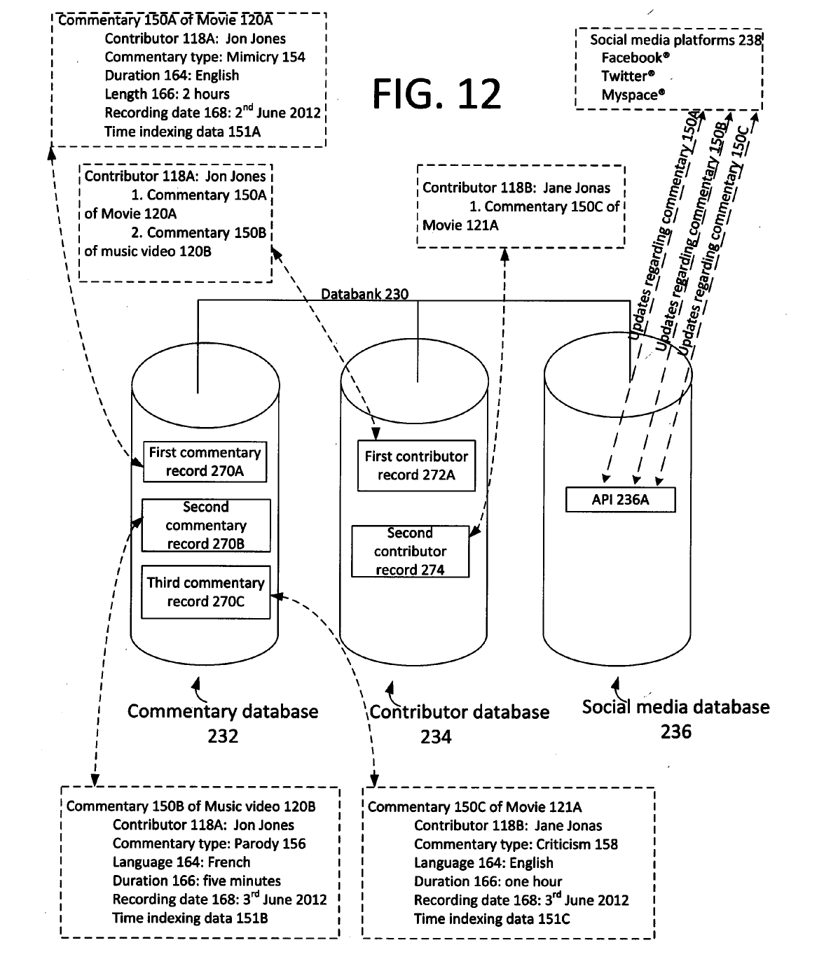

Assume now that a second contributor 118B named Jane Jonas views the media content 120 (e.g., a movie 121A) and uses the method 300 to record a commentary 150C of the movie 121A. Assume further that the commentary 150C is a criticism 158, has a duration 166 of one hour, is recorded on 3 Jun. 2012, is in the English language, and has time indexing data 151C. As shown in FIG. 12, the commentary 150C and these identifying attributes 152 of the commentary 150C may also be saved in the commentary database 232 in a third commentary record 270C. Further, as the commentary 150C is uploaded, a second contributor record 274 may be created to indicate that the contributor 118B (i.e., Jane Jonas) has created the commentary 150C of the movie 121A. The application programming interface 236A of the social media database 236 may similarly send updates to the social media platforms 238 regarding the new commentary 150C.

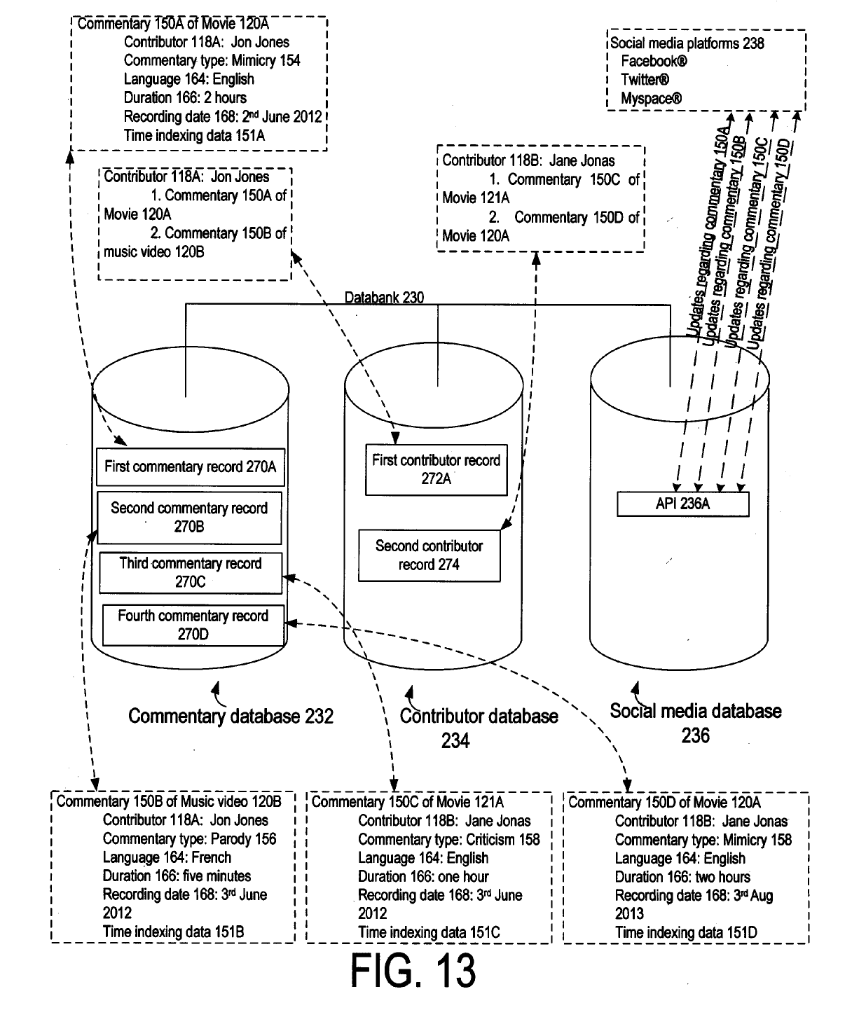

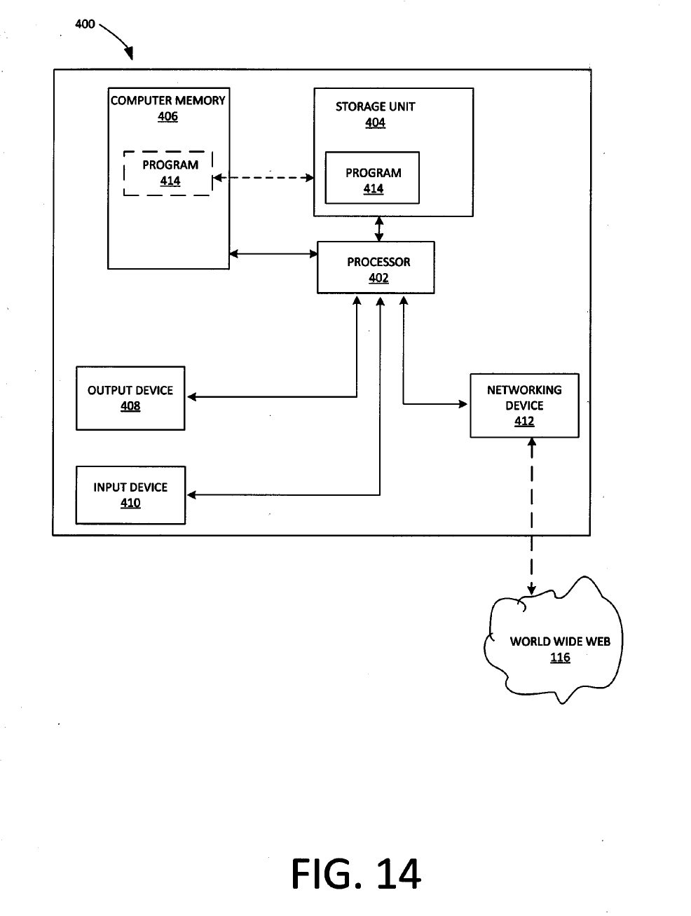

Assume now that the second contributor 118B (i.e., Jane Jonas) views the media content 120 (e.g., the movie 120A, which was previously viewed and commented on by contributor 118A) and utilizes the method 300 to record a commentary 150D. Assume further that the commentary 150D is a mimicry 154, has a duration 166 of two hours, is recorded on 3 Aug. 2013, is in the English language, and has time indexing data 151D. As shown in FIG. 13, the commentary 150D and these identifying attributes 152 of the commentary 150D may, consistent with the prior examples, be saved in the commentary database 232 in a fourth commentary record 270D. Further, as the commentary 150D is uploaded, the second contributor record 274 may be updated to indicate that the contributor 118B (i.e., Jane Jonas) has created the commentary 150D of the movie 120A. The application programming interface 236A of the social media database 236 may similarly send updates to the social media platforms 238 regarding the new commentary 150D.

In this manner, thus, multiple (e.g., hundreds of thousands) contributors 118 may conveniently view existing media content 120 on one device (e.g., the content playback device 100) and record commentaries 150 regarding the media content 120 on another device (e.g., the content acquisition device 200 such as a laptop, desktop, smart phone, tablet, smart TV, blue-ray player, et cetera). Information regarding each of these commentaries and commentators may be saved in the databank 230, as discussed above with respect to the commentary 150A of the contributor 118A.

In some embodiments, the content playback device 100 and the content acquisition device 200 may be the same device (e.g., a laptop computer, a desktop computer, a tablet, a smart phone, et cetera) and the contributor 118 may view the media content 120 on the output 108 (or 208, such as a display) and simultaneously record the commentary 150 using the input 110 (or 210, which may comprise a microphone and/or a camera) of the same device. People of skill in the art will appreciate that in these embodiments, the various functions outlined above (such as the recording by the recording application 220, the time synchronization by the time synchronizing application 171T, the uploading of the commentaries 150 to the databank 230, et cetera) may all be performed on the same device in tandem with the playback of the media content 120.

### Content Delivery

Attention is directed now to FIG. 13, which shows a content delivery device 400. Much like the content playback device 100 and the content acquisition device 200, the content delivery device 400 may be any smart device and have a processor (or controller) 402 in data communication with a storage unit 404, a computer memory 406, an output device 408, an input device 410, and a networking device 412. The storage unit 404 may be, for example, a disk drive that stores programs and data, and the storage unit 404 is illustratively shown storing a program 414 embodying the steps and methods set forth below. It should be understood that the program 414 could be broken into subprograms and stored in storage units of separate devices and that data could be transferred between those storage units using methods known in the art. A dashed outline within the computer memory 406 represents the software program 414 loaded into the computer memory 406 and a dashed line between the storage unit 404 and the computer memory 406 illustrates the transfer of the program 414 between the storage unit 404 and the computer memory 406. The output device 408 may be a display screen (e.g., a CRT, LCD, Plasma, et cetera) and/or speakers, or any other appropriate visual or audio output device whether now known or later invented. The input device 410 may comprise keys, switches, knobs, infrared or other sensors, a remote controller, a microphone, a stylus pen, a touch screen, a DVD or VHS input slot, et cetera. The networking device 412 may be any networking device that allows the media viewing device 100 to connect to a world wide web (i.e., the internet, or to or a private or local network) 116, such as a switch, a router, a modem, a networking card, et cetera.

When viewing the media content 120, users (or consumers) 418 may wish to listen to (or view) in conjunction therewith the commentary 150 submitted by a contributor 118 regarding that media content 120. This may be particularly true for the media content 120 that is in its residual phase (i.e., media content 120 whose novelty has worn off, e.g., movies such as Caddyshack, Reservoir Dogs, et cetera). The commentaries 150 may allow the consumers 418 to view the media content 120, so to speak, in a new light through the eyes of the commentators 118.

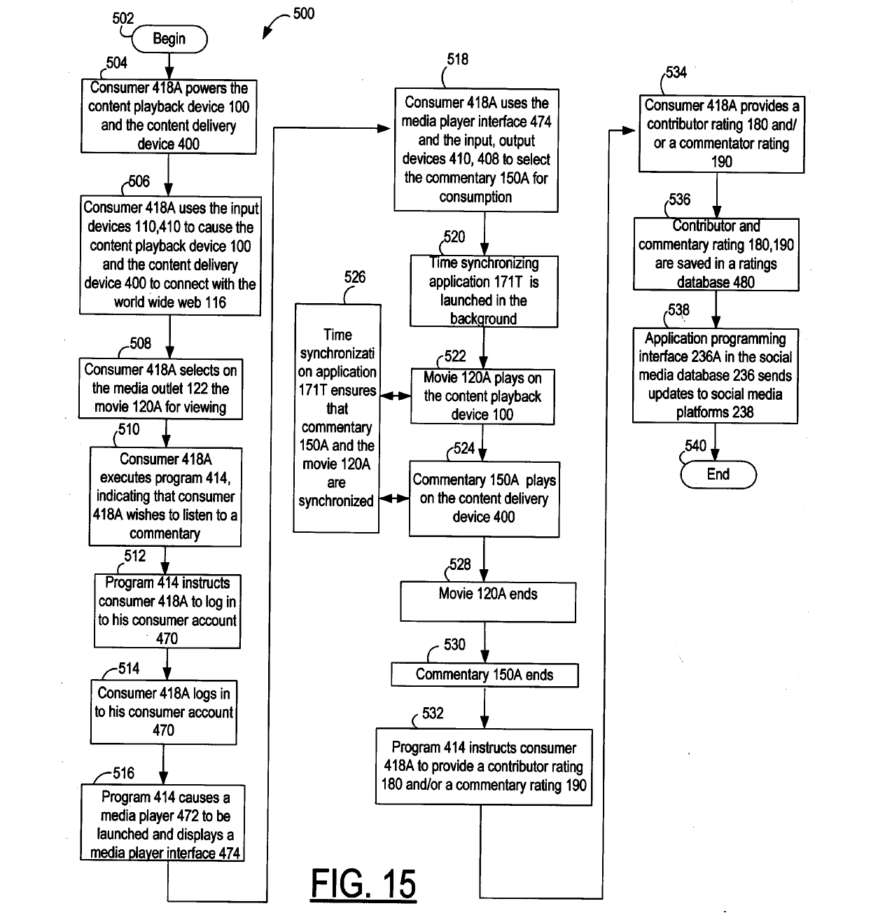

Attention is directed now to FIG. 15, which illustrates a method 500 for a consumer 418A named Jay Johnson to enjoy the commentary 150A along with the movie 120A. The method 500 may begin at step 502, and at step 504, the consumer 418A may power the content playback device 100 and the content delivery device 400. People of skill in the art will appreciate from the disclosure herein that the content delivery device 400 may also be powered at a subsequent step, and that the powering of the devices 100, 400 may not be required to effectuate the method 500 where the devices 100, 400 are already powered up at step 502.

Once the devices 100, 400 are powered, at step 506, the consumer 418A may use the input device 110 and the networking device 112 of the content playback device 100 to connect with the media outlet 122 via the world wide web 116. The consumer 418A may similarly use the input device 410 of the content delivery device 400 to connect to the web 116 using the networking device 412.

At step 508, the consumer 418A may select the movie 120A for viewing (from, for example, a listing of media content 120 made available by the media outlet 122). At step 510, the consumer 418A may execute the program 414 to indicate that the consumer 418A wishes to listen to (or view) the commentary 150. In some embodiments, the media outlet 122 may automatically execute the program 414 or display advertising to entice the consumer 418A to consume the commentary 150 along with the movie 120A.

At step 512, the program 414 may instruct the consumer 418A (e.g., via the processor 402 and the output device 408) to log into a consumer account 470, and the consumer 418A may do so at step 514 (using, for example, the input device 410). Much like the contributor account 170, the consumer account 470 may be specific to the consumer 418A and be password protected and/or encrypted. In some embodiments, the consumer account 470 may be tied to (and have the same log-in information as) an e-mail account of the consumer 418A and/or an account of consumer 418A on one or more of the social media platform 238. The consumer 418A may log into his consumer account 470 at step 514.

At step 516, the program 414 may cause a media player 472 to be launched. The media player 472 may be configured to play audio and video data files, and have an interface 474 for allowing the consumer 418A to select a commentary 150 that may be played with the movie 120A. In some embodiments, the media player 472 may communicate with the content playback device 100 (and/or the media outlet 122) and automatically ascertain the media content 120 (here the movie 120A) that the consumer 418A has selected for viewing via the media outlet 122. In other embodiments, the interface 474 may direct (e.g., via the output device 408) the consumer 418A to input the title of the media content 120 which the consumer 418A has selected for viewing.

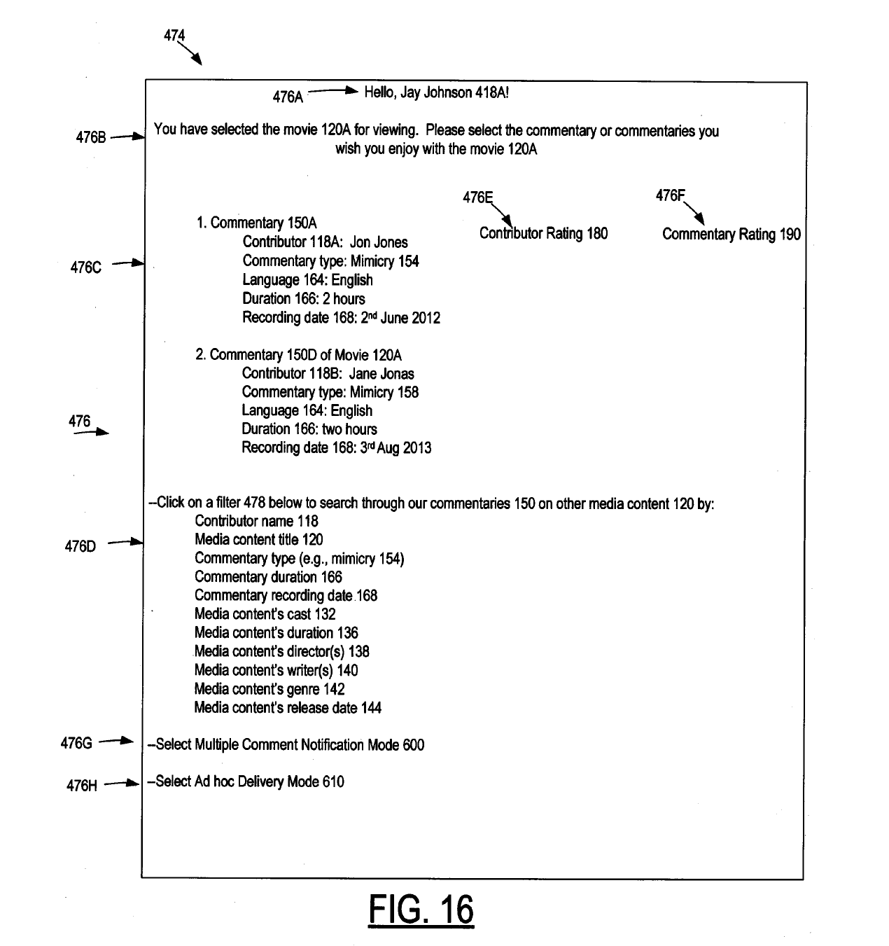

FIG. 16 shows a home screen 476 of the interface 474. People of skill in the art will appreciate that the interface 474 is exemplary only and that a different media player with a different interface may also be used for the selection and playing of the commentary 150. The home screen 476 of the interface 474 may have a first segment (or section) 476A, a second segment 476B, a third segment 476C, a fourth segment 476D, a fifth segment 476E, a sixth segment 476F, a seventh segment 476G, and an eight segment 476H.

The first segment 476A of the home screen 476 may, for example, include a greeting for the consumer 418A, and the second segment 476B may list the title of the movie 120A that the consumer 418A has selected for viewing via the media outlet 122 (see FIG. 16). The third segment 476 C may, for example, include a listing of one or more commentaries 150 that have been published by the contributors 118 regarding the media content 120 that the consumer 418 has selected for viewing. For example, as shown in FIG. 16, with respect to the movie 120A, the third segment 476C may list the commentary 150A and the commentary 150D (which, as discussed above, were submitted by contributor 118A (i.e., Jon Jones) and contributor 118B (i.e., Jane Jonas), respectively). Some or all of the identifying attributes 152 of the respective commentaries 150 may also be provided to assist the consumer 418A in making his or her selection.

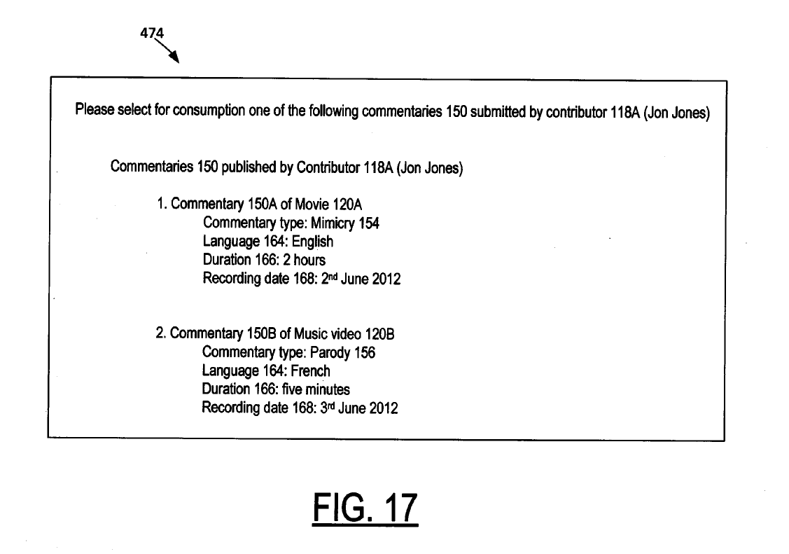

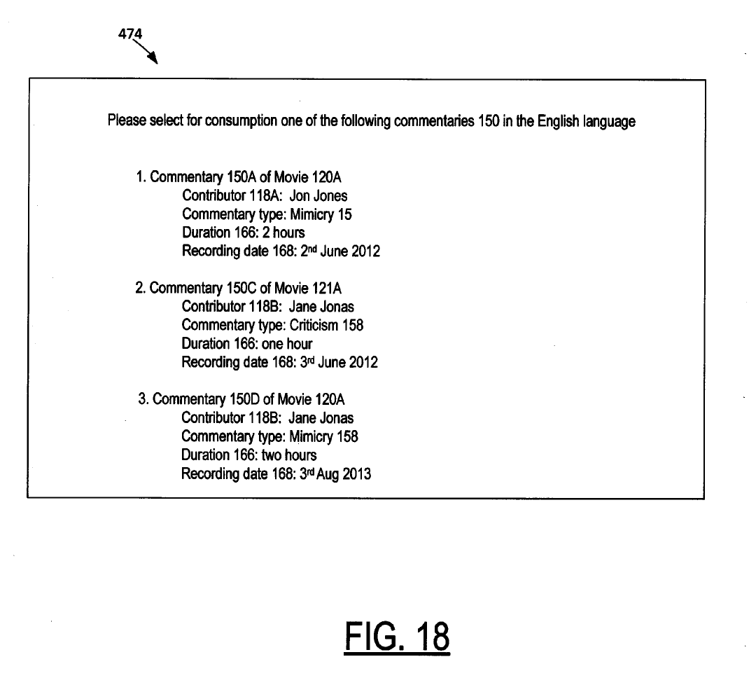

The fourth segment 476D of the home screen 476D may include a tab that the consumer 418A may select to view a listing of commentaries 150 in the databank 230 on other media content 120. For example, the consumer 418A may be allowed to search through the various commentaries 150 in the databank 230 using one or more of a plurality of filters 478. The filters 478 may allow the consumer 418A to search through the various commentaries 150 using any of the identifying attributes 152 of the commentaries 150 and/or the identifying characteristics 130 of the media content 120; for example, the consumer 418A may search the commentaries 150 using the contributor name 118, the media content title 120, the commentary type (e.g., mimicry 154, parody 156), the commentary duration 166, commentary recording date 168, the media content's cast 132, the media content's duration 136, media content's director(s) 138, the media content's writer(s) 140, the media content's genre 142, the media content's release date 144, et cetera. For example, if the consumer 418A uses the contributor name 118 (e.g., contributor 118A, i.e., Jon Jones) as the filter 478, the media player interface 474 may list all the commentaries 150 that the contributor 118A (Jon Jones) has published (see FIG. 17). Or, for example, if the consumer 418A uses the commentary language 164 (e.g., English) as the filter 478, the media player interface 474 may list all the commentaries 150 in the English language (see FIG. 18). One or more other filters 478 (e.g., commentary duration 166, media content's genre 142, et cetera) may similarly be employed the by consumer 418A to conveniently sift through and select from the multitude of commentaries 150 in the databank 230.

As shown in FIG. 16, the home screen 474 may also include a commentary rating 180 at the fifth segment 476E and a contributor rating 190 at the sixth segment 476F. The home screen 474 may further allow the user to select a multiple comment notification mode 600 at the seventh segment 476G or an ad hoc delivery mode 610 at the eight segment 476H. The commentary and contributor ratings 180, 190, and the multiple comment notification and ad hoc delivery modes 600, 610, respectively, are discussed further below. Attention is directed back to the method 500 at FIG. 15.

After the media player 472 is launched at step 516, the consumer 418A at step 518 use the media player interface 474 and the input, output devices 410, 408 of the content delivery device 400 to select a commentary for consumption with the movie 120A. Assume, for example, that the consumer 418A chooses to listen to the commentary 150A (published by contributor 118A) at step 518. Alternatively, the consumer 418A may have chosen to listen to the commentary 150D (published by contributor 118B).

At step 520, the program 414 may cause the time synchronizing application 171T to be launched in the background. The movie 120A may begin to play on the content playback device 110 (e.g., at the direction of the program 114 and/or the program 414) at step 522. At step 524, the program 414 may cause the commentary 150A to play on the content delivery device 400.

The consumer 418A may enjoy the movie 120A on the content playback device 100, and simultaneously enjoy the commentary 150A on the content delivery device 400. While the movie 120A and the commentary 150A are playing, the time synchronization application 171T may continue to run in the background at step 526 and use the time indexing data 151A to ensure that the commentary 150A and the movie 120A are adequately synchronized. Thus, the consumer 418A may view the media content 120 (i.e., the movie 120A in this example) via any media outlet 122 and enjoy the synchronized commentary 150 therewith. Notably, as the consumer 418A consumes the commentary 150A with the media content 120A (using Netflix as the media outlet 122, for example), the commentary 150A may be presented to the consumer 418A in sync with the media content 120A even though the contributor 118 may have recorded the commentary 150A when viewing the media content 120A using a different media outlet 122 (Hulu, for example). As noted above, because of differing length of previews, advertisements, starting credits, disparate buffering speeds, et cetera, of the different media outlets 122, the timelines of the same media content 120A when viewed using two different media outlets 122 may not align. The time synchronization application 171T may use the time indexing data 150A to account for such differences in the timelines. For example, if a particular scene of the media content 120A is played for the contributor 118 three minutes after he begins viewing the media content 120A but is played for the consumer 418A four minutes after he begins viewing the media content 120A (using for example a different media outlet 122), the polling by the time synchronization application 171T may ensure that the commentary 150A associated with that particular scene is played for the consumer 418A when that particular scene is being viewed by the consumer 418A (i.e., four minutes after playback begins in this example), irrespective of the fact that the commentary 150A associated with this particular scene was recorded by the contributor 118A three minutes after playback of the media content 120A began.

The movie 120A may end at step 528 and the commentary 150A may end at step 530. At step 532, the program 414 may direct the consumer 418A to provide a contributor rating 180 and/or a commentary rating 190, and the consumer 418A may do so at step 534.

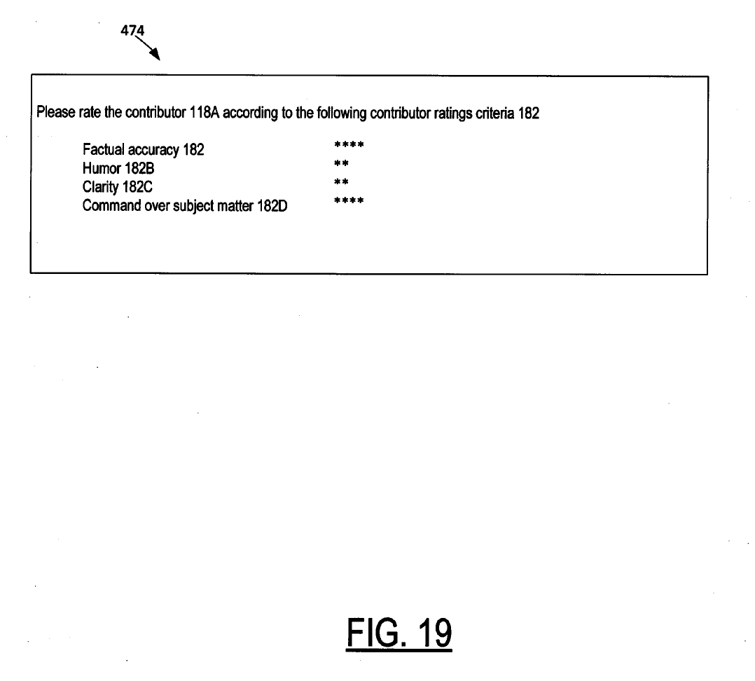

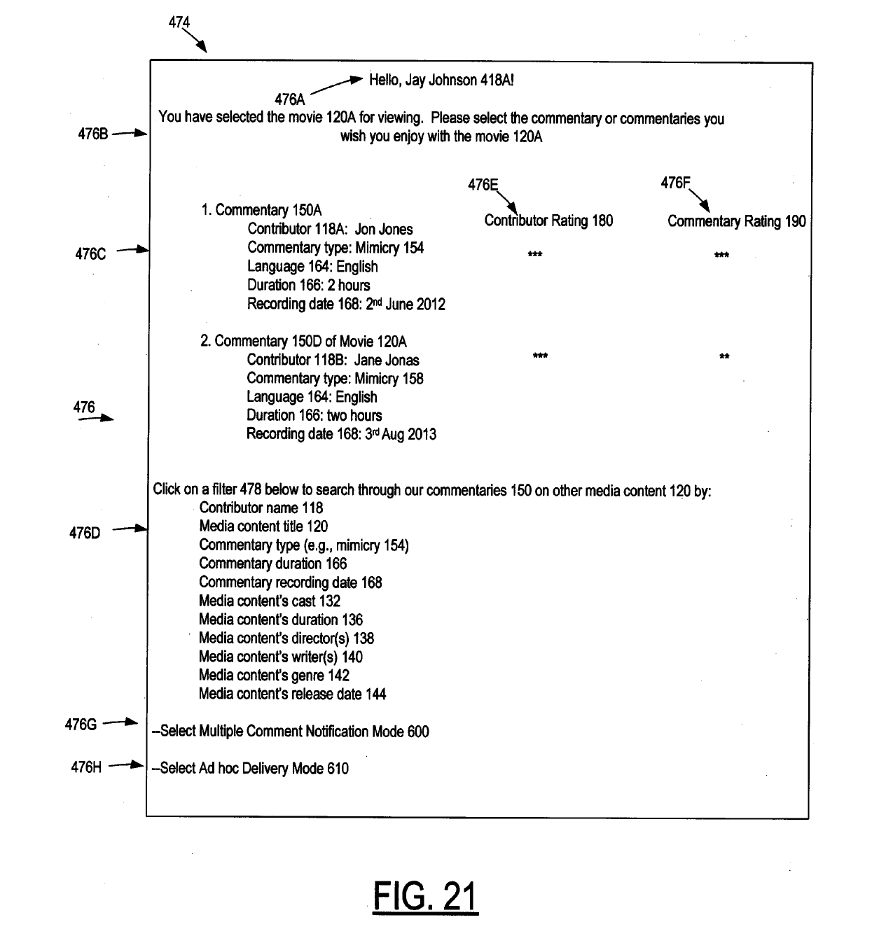

The contributor rating 180 may range from zero to five stars (or zero to ten stars in some embodiments), and may be based on contributor rating criteria 182. The contributor rating criteria 182 may, for example, include factual accuracy 182A, humor 182B, clarity 182C, command over subject matter 182D, et cetera. The consumer 418A may be directed at step 532 to rate the contributor 118A from one to five stars under each of these categories, and the program 414 may then average these various ratings to determine the contributor rating 180. For example, as shown in FIG. 19, the consumer 418A may give the contributor 118A four stars on factual accuracy 182, two stars on each of humor 182B and clarity 182C, and four stars on command over subject matter 182D. The program 414 may thus determine that the contributor rating 180 for the contributor 118A is three stars (i.e., (4+2+4+2)/4=3)) (see FIG. 21).

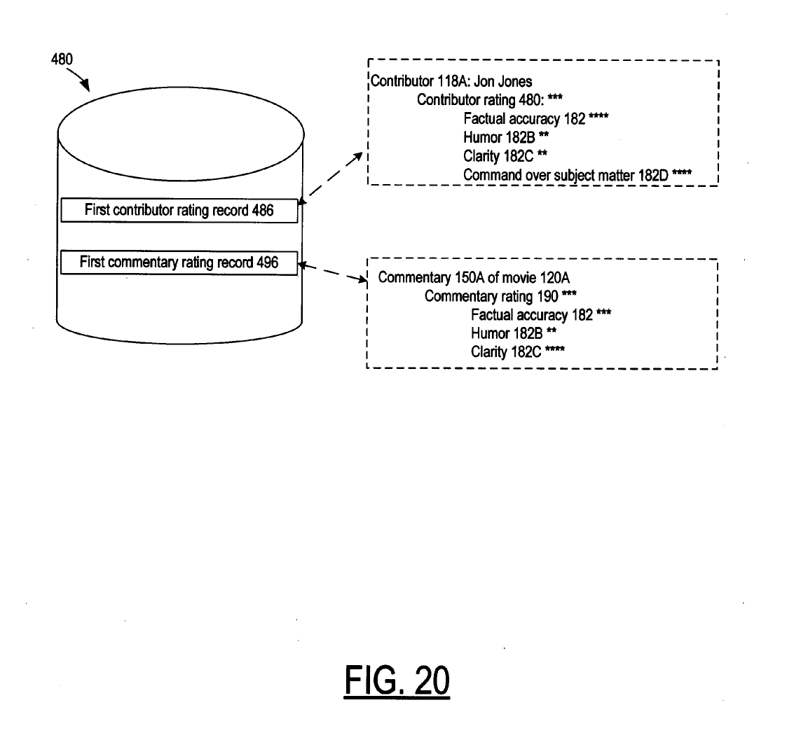

The commentary rating 190 may similarly range from zero to five stars (or zero to ten stars in some embodiments), and may be based on commentary rating criteria 192, which in some embodiments may include some or all of the contributor rating criteria 182 (i.e., include criteria such as factual accuracy 182A, humor 182B, clarity 182C, et cetera.) The consumer 418A may be directed at step 532 to rate the commentary 118A from one to five stars under each of these categories, and the program 414 may then average these various ratings to determine the commentary rating 190. For example, as shown in FIG. 20, the consumer 418A may give the commentary three stars on factual accuracy 182, two stars on humor 182B and four stars on clarity 182C. The program 414 may thus determine that the commentary rating for the commentary 150A is three stars (i.e., (3+2+4)/3=3)) (see FIG. 21).

After the consumer 418A has entered the contributor rating 180 and/or the commentary rating 190 at step 534, the ratings 180, 190 (along with, in some embodiments, the ratings given by the consumer 418A on the individual criteria 182, 192) may be uploaded to a ratings database 480 at step 536. Specifically, as shown in FIG. 20, the contributor rating 180 may be saved in the ratings database 480 in a first contributor rating record 486 and the commentary rating 190 may be saved in the ratings database 480 as a first commentary rating record 496. When a consumer 418 (e.g., Jay Johnson 418A) subsequently uses the method 500 to consume the commentary 150A, the program 414 may cause these contributor ratings 180 and/or the commentary ratings 190 to be displayed on the home screen 476 to assist the consumer 418 in making his selection (see FIG. 21).

People of skill in the art will appreciate that while the contributor ratings 180 and the commentary ratings 190 have been illustrated herein with regard to a single consumer 418 (i.e., consumer 418A), that the ratings database 480 may similarly house the contributor ratings 180 and/or the commentary ratings 190 submitted by multiple (e.g., hundreds of thousands) of consumers 418 regarding different types of media content 120. The program 414 may be configured to average the ratings submitted by the multiple consumers 418 before displaying them on the home screen 474 at the fifth and sixth segments 476E, 476F, respectively. In some embodiments, the filter 478 may include the contributor ratings 180 and/or the commentary ratings 190 (i.e., consumers 418 may be allowed to search through contributors 118 and/or commentaries 150 that are rated at three stars or above, rated at four and a half stars, rated at between four stars and five stars, et cetera). In some embodiments, the contributor ratings 180 and/or the commentary ratings 190 may be devoid of the criteria 182, 192, and the consumers 418 may simply rate the contributors 118 and/or the commentaries 150 from one to five stars. In some embodiments, the ratings database 480 may be part of the databank 230.

Returning back to the method 500 at FIG. 15, once the contributor ratings 180 and/or the commentary ratings 190 have been uploaded to the ratings database 480 at step 536, the application programming interface 236A of the social media database 236 may send updates to social media platforms 238. For example, the application programming interface 236A may update the contributor 118A's and/or the consumer 418A's Facebook® page indicating that the consumer 418A has viewed the commentary 150A and given the contributor 118A and/or the commentary 150A a three star rating.

As discussed above, the contributor 118 may use a single device (e.g., the media viewing device 100) to view the media content 120 and record the commentary 150, or use two separate devices for the viewing of the media content 120 and the recording of the commentary 150 (e.g., the media viewing device 100, and the content acquisition device 200, respectively). Similarly, the consumer 418 may use two separate devices for consuming the media content 120 and the commentary 150 (e.g., the media viewing device 100 and the content delivery device 400, respectively), or use a single device (e.g., the media viewing device 100) to enjoy the commentary 150 and the media content 120 simultaneously.

Thus, as has been described, the present invention may make existing media content 120 fully interactive by allowing contributors 118 to provide commentaries 150 on the same. The invention may in this way breathe new life into the existing media content 120 by allowing commentaries 150 to be consumed in conjunction therewith, and by virtue of, for example, the social media database 236, advertise these commentaries 150 which may in turn peak the public's interest in the underlying media content 120.

As outlined above, a contributor 118 may use the present invention (e.g., the method 300) to, inter alia, view a media content 120 and record a commentary 150 therewith, and a consumer 418 may use the present invention (e.g., the method 500) to, among other things, watch the media content 120 and consume therewith the recorded commentary 150 in sync with the media content. The disclosure above generally illustrates the contributor 118 recording one commentary 150 for the entire duration of the media content 120, and the consumer 418 consuming only that one commentary 150 along with the media content 120. People of skill in the art will appreciate from the disclosure herein, however, that the invention is not so limited.

### Content Delivery—Special Modes of Operation

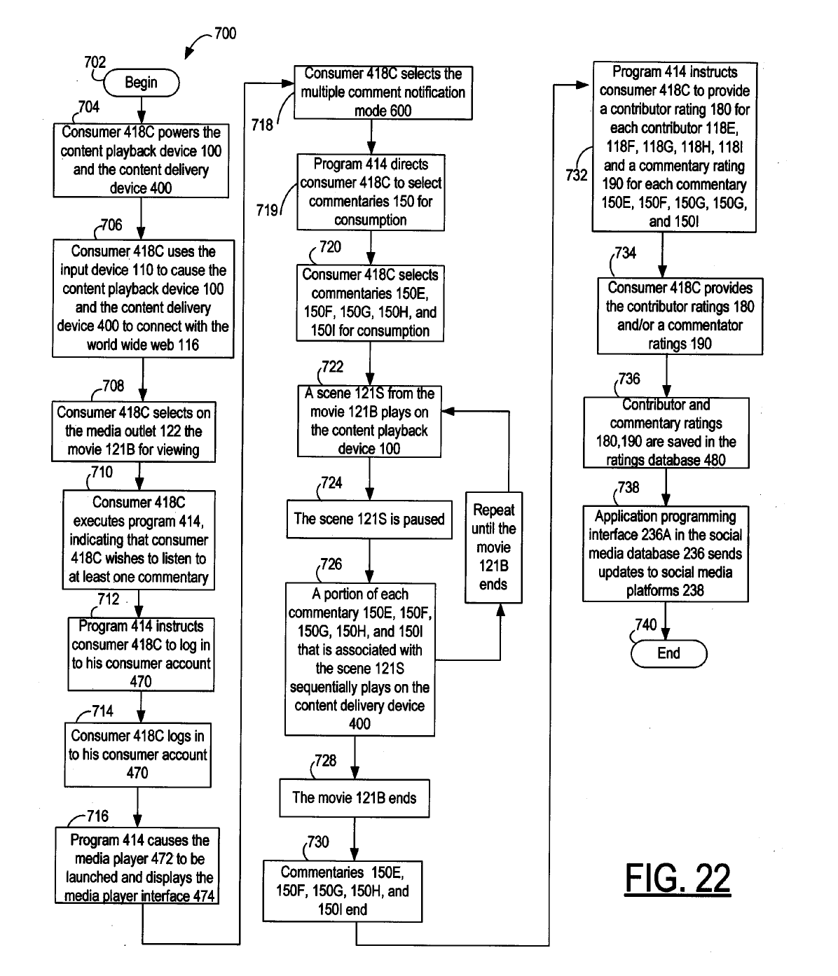

The present invention may also allow consumers 418 to consume multiple commentaries 150 from multiple contributors 118 while viewing the media content 120 (e.g., a movie). Specifically, a consumer 418C may utilize the multiple comment notification mode 600 (see FIG. 16), functionality for which may be, for example, provided via the program 414, to select a plurality of commentaries 150 for consumption with the media content 120. Assume, for example, that five contributors 118E, 118F, 118G, 118H, and 118I have respectively recorded commentaries 150E, 150F, 150G, 150H and 150I associated with a movie 121B, and that these commentaries and the information regarding these contributors and commentaries is saved in the databank 230 in line with the discussion above. Attention is directed now to FIG. 22, which shows a method 700 for utilizing the multiple comment notification mode 600.

The method 700 may begin at step 702, and at step 704, the consumer 418C may power the content playback device 100 and the content delivery device 400. At step 706, the consumer 418C may use the input device 110 and the networking device 112 of the content playback device 100 to connect with the media outlet 122 via the world wide web 116. The consumer 418C may similarly use the input device 410 of the content delivery device 400 to connect to the web 116 using the networking device 412.

At step 708, the consumer 418C may select the movie 121B for viewing (from, for example, a listing of media content 120 made available by the media outlet 122). At step 710, the consumer 418C may execute the program 414 to indicate that the consumer 418C wishes to listen to (or view) at least one commentary 150

At step 712, the program 414 may instruct the consumer 418C (e.g., via the processor 402 and the output device 408) to log into his consumer account 470, and the consumer 418C may do so at step 714 (using, for example, the input device 410).

At step 716, the program 414 may cause the media player 472 to be launched and display the media player interface 474 (FIG. 16). At step 718, the consumer 418C may select the multiple comment notification mode 600. The program 414 may, at step 719, direct the consumer 418C to select two or more commentaries 150 for consumption with the movie 121B. The consumer 418C may select the commentaries 150E, 150F, 150G, 150H, and 150I at step 720.

At step 722, a scene 121S from the movie 121B may begin to play on the content playback device 100. At step 724, once the scene 121S ends, the program 114 (or 414) may cause the playback of the movie 121B to be paused (i.e., stopped). The program 414 may then cause at step 726 the portion of the commentary 150E that is associated with the scene 121S to play on the content delivery device 400. Thereafter, the program 414 may cause the portion of the commentary 150F that is associated with the scene 121S to play on the content delivery device 400. Similarly, the program 414 may sequentially play those portions of the commentaries 150G, 150H and 150I that are associated with the scene 121S.

Steps 722 through 726 may be repeated until the movie 121B ends. Specifically, after each scene, the playback of the movie 121B may be paused (i.e. stopped) and the portions of the commentaries 150E, 150F, 150G, 150H, and 150I that are associated with that scene may be sequentially played on the content delivery device 400. The consumer 418C may thus enjoy multiple points of view of multiple contributors 118 while viewing the movie 121B.

The movie 121B may end at step 728, and the commentaries 150E, 150F, 150G, 150H, and 150I may end at step 730. At step 732, the program 414 may instruct the consumer 418C to provide a contributor rating 180 for each contributor 118E, 118F, 118G, 118H, and 118I, and a commentary rating 190 for each commentary 150E, 150F, 150G, 150H, and 150I, and the consumer 418C may do so at step 734. The ratings 180, 190 may be saved in the ratings database 480 at step 736 as discussed above. The program 414 may then cause the application programming interface 236A to send updates to social media platforms 238 at step 738. The method 700 may end at step 740.

In some embodiments, the multiple comment notification mode 600 may allow the consumer 418 to select, scene by scene (or every five, ten, fifteen, minutes, for example), the commentaries 150 that the consumer 418 wishes to enjoy with the media content 121B. The consumer 418 may thus, for example, enjoy certain commentaries 150 with certain scenes of the movie 121B and other commentaries 150 with other scenes of the movie 121B (or other media content 120).

It will be appreciated that some consumers 418 may be more interested in consuming a commentary 150 than in viewing the media content 120 with which the commentary 150 is associated. The ad hoc delivery mode 610 (FIG. 16) may allow consumers 418 to consume multiple commentaries 150 in a continuous fashion without viewing the media content 120. For example, a consumer 418 may use the ad hoc delivery mode 610 to sequentially consume the ten most recent commentaries 150 that have been uploaded to the databank 230 (or the server 240). Additionally, the ad hoc delivery mode 610 may allow consumers to view only a portion of the media content 120 (e.g., one scene) and consume therewith a plurality of commentaries 150 from multiple contributors 118 that are associated with that portion of the media content 120.

Thus, as has been described, the present invention may: (1) make existing media content 120 fully interactive by allowing contributors 118 to provide commentaries 150 on all or part of the media content 120; (2) compile and organize the media content 120 and the commentaries 150 of the contributors 118 for consumption by the consumers 418; and (3) provide a mechanism to rate the numerous contributors 118 and commentaries 150 based on various criteria so as to enable the consumers 418 to choose the one or more contributors 118 and commentaries 150 according to their personal tastes and preferences.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A system for storing a first commentary and a second commentary each provided by a contributor and delivering said commentaries to a consumer, the first commentary being associated with a first media content and the second commentary being associated with a second media content, the system comprising:
a content playback device configured for the playback of the first media content and the second media content, the content playback device comprising a first processor in data communication with a first non-transitory computer memory, a first input device, a first output device, and a first networking device;
a content acquisition device configured for the recording of the first and the second commentaries provided by the contributor, the content acquisition device comprising a second processor in data communication with a second non-transitory computer memory, a second input device, a second output device, a second networking device, and a microphone; and
a databank accessible over a network and comprising at least a commentary database and a contributor database, the first commentary being housed in the commentary database in a first commentary record and the second commentary being housed in the commentary database in a second commentary record, the first commentary record further comprising a first set of time indexing data and the second commentary record further comprising a second set of time indexing data for allowing respective synchronization of the first commentary and the second commentary with the first media content and the second media content, the contributor database housing an attribute of the contributor;
wherein each of the first commentary and the second commentary are respectively delivered to a consumer in sync with the first media content and the second media content.

2. The system of claim 1 wherein the databank further comprises a social media database configured to interact with at least one social media platform.

3. The system of claim 2 wherein the databank further comprises a ratings database for storing a contributor rating provided by the consumer.

4. The system of claim 3 wherein the ratings database further comprises a first commentary rating and a second commentary rating each provided by the consumer.

5. The system of claim 4 wherein the first commentary is identified in the first commentary record as one of a mimicry and a parody.

6. The system of claim 5 wherein the first commentary record further includes a duration of the first commentary.

7. The system of claim 6 wherein the attribute comprises the name of the contributor.

8. The system of claim 6 wherein at least one of the first media content and the second media content is a motion picture.

9. A computer implemented method for storing and delivering to a consumer a first commentary provided by a first contributor and a second commentary provided by a second contributor, each of the first and the second commentaries being associated with a first scene of a media content, the method comprising steps:
storing in a first commentary record of a commentary database the first commentary and a first set of time indexing data;
storing in a second commentary record of the commentary database the second commentary and a second set of time indexing data;
using a content delivery device having at least a processor, a non-transitory memory, an input device, an output device, and a networking device to playback the media content for the consumer;
causing the playback of the media content to be paused after the playback of the first scene;
causing the first commentary to be played for the consumer on the content delivery device;
causing the second commentary to be played for the consumer on the content delivery device once playback of the first commentary has ended; and
causing playback of the media content to be resumed on the content delivery device upon conclusion of the second commentary.

10. The method of claim 9 further comprising the steps of:
obtaining from the consumer a first contributor rating of the first contributor and a second contributor rating of the second contributor;
storing in a ratings database the first contributor rating and the second contributor rating.

11. The method of claim 10 further comprising the steps of:
obtaining from the consumer a first commentary rating of the first commentary and a second commentary rating of the second commentary;
storing the first commentary rating and the second commentary rating in the ratings database.

12. The method of claim 11 wherein the first contributor rating is based on a contributor ratings criteria and the first commentary rating is based on a commentary ratings criteria.

13. The method of claim 12 further comprising the step of storing an identifying attribute of the first contributor in a contributor database.

14. The method of claim 13 wherein the media content is a motion picture in its residual phase.

15. A computer implemented method for storing and delivering to a consumer a first commentary provided by a first contributor and a second commentary provided by a second contributor, the first commentary being associated with a first scene of a media content, the second commentary being associated with a second scene of the media content, the method comprising steps:
storing in a first commentary record of a commentary database the first commentary and a first set of time indexing data;
storing in a second commentary record of the commentary database the second commentary and a second set of time indexing data;
using a content delivery device having at least a processor, a non-transitory memory, an input device, an output device, and a networking device to playback the media content for the consumer;
causing the playback of the media content to be paused after the playback of the first scene;
causing the first commentary to be played for the consumer on the content delivery device while the playback of the media content is paused;
causing the playback of the media content to be resumed upon conclusion of the first commentary;
causing the playback of the media content to be stopped after the playback of the second scene;
causing the second commentary to be played for the consumer on the content delivery device while the playback of the media content is stopped; and
causing the playback of the media content to be resumed on the content delivery device upon conclusion of the second commentary.

16. The method of claim 15 further comprising the steps of:
obtaining from the consumer a first commentary rating of the first commentary and a second commentary rating of the second commentary;
storing the first commentary rating and the second commentary rating in a ratings database.

17. The method of claim 15 further comprising the steps of:
obtaining from the consumer a first contributor rating of the first contributor and a second contributor rating of the second contributor;
storing the first contributor rating and the second contributor rating in a ratings database.

18. The method of claim 17 wherein a duration of the first commentary is greater than a duration of the second commentary.

19. The method of claim 18 wherein at least one of the first commentary and the second commentary is a parody.

20. The method of claim 19 wherein the first commentary is in a first language and the second commentary is in a second language.
